(19) United States
(12) Patent Application Publication
(10) Pub. No.: US 2025/0205913 A1
(43) Pub. Date: Jun. 26, 2025

(54) ADJUSTABLE BLADESET FOR HAIR CUTTING DEVICE AND HAIR CUTTING DEVICE INCORPORATING SAME

(71) Applicant: WAHL CLIPPER CORPORATION, Sterling, IL (US)

(72) Inventors: Ryan Matthew VARGA, Dixon, IL (US); Steven Wayne ARNDT, Geneseo, IL (US); Curtis J. DE FRANG, Sterling, IL (US); Ronaldo J. SANTIAGO, South Elgin, IL (US)

(21) Appl. No.: 18/934,578

(22) Filed: Nov. 1, 2024

Related U.S. Application Data
(60) Provisional application No. 63/613,514, filed on Dec. 21, 2023.

(51) Int. Cl. B26B 19/06; B26B 19/20

(52) U.S. Cl. CPC B26B 19/063; B26B 19/205

(57) ABSTRACT

A bladeset for an electric hair cutting device includes a moving blade, a stationary blade, and an adjustment mechanism for adjusting a position of the moving blade relative to the stationary blade to allow for user control of a length of hair cut by the device. The bladeset includes provisions for maintaining sufficient parallelism of the moving blade relative to the stationary blade despite its adjustability.

### RELATED APPLICATION

The present application claims the benefit under 35 U.S.C. 119(e) of U.S. Provisional Application No. 63/613,514 filed Dec. 21, 2023, the entire contents of which are incorporated by reference herein.

### BACKGROUND

The present invention relates generally to electric hair cutting devices such as hair clippers and hair trimmers, and more specifically to a hair trimmer utilizing a taper lever or similar mechanism for cutting length adjustment.

Electric hair cutting devices such as hair clippers and hair trimmers feature an electric motor powering a moving blade of a bladeset in a laterally reciprocating manner in relation to a stationary blade. Both the moving blade and the stationary blade have teeth, and both blades are collectively referred to as the bladeset. Hair caught between the teeth of the blades is sheared through movement of the moving blade relative to the stationary blade. The electric motor is powered by an on-board battery, or via a supply voltage from an outlet. The motor is mechanically coupled to the moving blade to produce the reciprocation.

Additional features may also be included, such as cutting length adjustment mechanisms used to finely control of the length of hair cut by the device. One such cutting length adjustment mechanism in general involves moving the stationary blade relative to the moving blade. The stationary blade has a variable thickness through which hair must pass before reaching the interface of the moving blade and stationary blade where it is cut. These mechanisms allow the user to set where, along the thickness of the stationary blade, the interface between the moving blade and stationary blade resides, and hence finely control how much hair is cut. These mechanisms typically employ some form of a mechanical actuator such as a taper lever to achieve this fine control.

While somewhat used interchangeably, hair clippers and trimmers are typically employed for different functions. A contemporary hair clipper is typically a larger more powerful unit than a contemporary hair trimmer and is typically utilized for bulk hair cutting, fading, and shaping. A hair trimmer is usually the tool of choice for finer detail work such as edging, lining, etc.

Due to the use of hair trimmers for detail work, the evolution of hair trimmer design has primarily focused on enhancing precision and user control. Traditional hair trimmers often relied on fixed cutting lengths, limiting versatility. One notable advancement has been the incorporation of cutting length adjustment mechanisms, offering users the ability to adjust cutting lengths seamlessly.

Some designs aim at achieving adjustable cutting lengths using mechanical systems such as those described above, while others have explored digital or electronic solutions, integrating electronic controls for length adjustment. An example of a contemporary hair trimmer utilizing a cutting length adjustment mechanism having a taper lever may be seen at U.S. Pat. No. 9,545,729 to Buck et al. titled “Hair Trimmer Blade Set With Adjustable Blades”, which is hereby incorporated by reference in its entirety. As will be readily appreciated by the foregoing, seamless cutting length adjustment while maintaining precise cutting performance continues to be a point of interest in the advancement of hair trimmer technology.

Accordingly, there is a continuing need for a hair trimmer which provides a cutting length adjustment mechanism that is highly reliable and delivers on precise user control without adding unnecessary complexity in its construction or operation.

### SUMMARY

The above-listed need is met or exceeded by a bladeset of an electric hair cutting device having a guiding system that promotes parallelism of a leading edge of the moving blade relative to a leading edge of the stationary blade. An embodiment of such a bladeset includes a stationary blade including a plurality of teeth, at least one guide rail extending transversely from a base surface of the stationary blade, and a moving blade including a plurality of teeth. The moving blade is operable to reciprocate in first and second cutting directions relative to the stationary blade to produce a cutting action.

An adjustment mechanism of the bladeset is operably coupled to the moving blade to adjust the moving blade in first and second adjustment directions. The first and second adjustment directions are perpendicular to both the first and second cutting directions. The bladeset also includes a blade guide including at least one guide channel formed therein. The at least one guide rail extends at least partially into the at least one guide channel and is in contact with the moving blade.

The at least one guide rail may include first and second guide rails arranged parallel to one another. The at least one guide channel may include first and second guide channels arranged parallel to one another. In such a configuration, the first guide rail extends into the first guide channel, and the second guide rail extends into the second guide channel.

The stationary blade includes a guide surface. At least a portion of the guide surface is parallel to at least a portion of the base surface. The at least one heel portion may include a first heel portion and a second heel portion. The at least one guide depression may include a first guide depression and a second guide depression. The first heel portion is received in the first guide depression, and the second heel portion is received in the second guide depression. In this configuration, the at least one guide depression and the at least one guide channel intersect such that the at least one guide rail supports the at least one heel portion within the at least one guide depression.

The above-listed need is also met or exceeded by a bladeset of an electric hair cutting device that has a moving blade and blade guide which include a high degree of precision and dimensional fidelity through their entire range of motion. An embodiment of such a bladeset includes a stationary blade including a plurality of teeth and having at least one blade guide receiving channel formed in a sidewall of the stationary blade. The bladeset also includes a moving blade including a plurality of teeth. The moving blade is operable to reciprocate in first and second cutting directions relative to the stationary blade to produce a cutting action.

An adjustment mechanism is operably coupled to the moving blade to adjust the moving blade in first and second adjustment directions. The first and second adjustment directions are perpendicular to both the first and second cutting directions. The bladeset also includes a blade guide contacting the stationary blade. The blade guide includes at least one guide portion. The at least one guide portion of the blade guide is received within the at least one blade guide receiving channel of the stationary blade.

The at least one blade guide receiving channel of the stationary blade may include a first blade guide receiving channel and a second blade guide receiving channel. The at least one blade guide portion of the blade guide may include a first blade guide portion and a second blade guide portion. The first blade guide portion is received within the first blade guide receiving channel. The second blade guide portion is received within the second blade guide receiving channel.

The stationary blade also includes a base and a guide plate. The guide plate is positioned within a cavity of the base. The guide plate defines a guide surface. The blade guide is slidable on the guide surface.

The above listed need is also met or exceeded by a bladeset of an electric hair cutting device having a streamlined adjustment mechanism. An embodiment of such an electric hair cutting device includes a stationary blade including a plurality of teeth and including a cavity. The bladeset also includes a moving blade including a plurality of teeth. The moving blade is operable to reciprocate relative to the stationary blade to produce a cutting action. The bladeset also includes a blade guide contacting the stationary blade. The bladeset also includes an adjustment mechanism having a taper lever and an armature. The armature is operably coupled between the taper lever and the blade guide such that the moving blade and the blade guide are movable relative to the stationary blade upon actuation of the taper lever. The armature is pivotally mounted to the stationary blade.

The stationary blade includes a base surface and a guide surface. At least a portion of the base surface is parallel to at least a portion of the guide surface. The cavity of the stationary blade is interposed between the base surface and the guide surface. The armature is pivotally mounted on the stationary blade about a pivot axis. The pivot axis is defined by a pivot pin extending from the stationary blade. The armature includes a pin portion extending upwardly from a base portion. The pin portion extends through a slot of a guide plate of the stationary blade and into a guide structure of the blade guide. The guide structure of the blade guide is positioned within the receiving opening of the moving blade. The cam surface is in slidable engagement with a pin extending from the taper lever.

The adjustment mechanism includes a first gear member, a second gear member, and a biasing element. The first gear member second gear member, and biasing element are situated within a cavity of the taper lever. The biasing element biases the first gear member into engagement with the second gear member. The first gear member is movable relative to the second gear member upon actuation of the taper lever.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a hair trimmer incorporating an embodiment of a bladeset constructed in accordance with the teachings herein;

FIG. 2 is a perspective exploded view of the bladeset of FIG. 1;

FIG. 3 is a perspective vertical cross sectional view of the bladeset of FIG. 1;

FIG. 4 is perspective view of the bladeset of FIG. 1;

FIG. 5 is perspective view of a portion of the bladeset of FIG. 1;

FIG. 6 is a perspective vertical cross sectional view of a portion of the bladeset depicted in FIG. 1;

FIG. 7 is a perspective view of a portion of a stationary blade and an adjustment mechanism of the bladeset of FIG. 1;

FIG. 8 is a top view of a portion of the bladeset of FIG. 1;

FIG. 9 is another top view of a portion of the bladeset of FIG. 1;

FIG. 10 is a perspective view of the bladeset of FIG. 1, including an alternative embodiment of a blade guide;

FIG. 11 is a perspective view of the blade guide of FIG. 10;

FIG. 12 is a perspective view of the bladeset of FIG. 1, including another alternative embodiment of a blade guide;

FIG. 13 is a perspective cross sectional view of the alternative embodiment of FIG. 12;

FIG. 14 is another perspective view of the bladeset of FIG. 1, including the alternative embodiment of the blade guide shown in FIG. 12;

FIG. 15 is a perspective view of the alternative embodiment of the blade guide shown in FIG. 12; and

FIG. 16 is a perspective exploded view of a portion of an adjustment mechanism of the bladeset of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

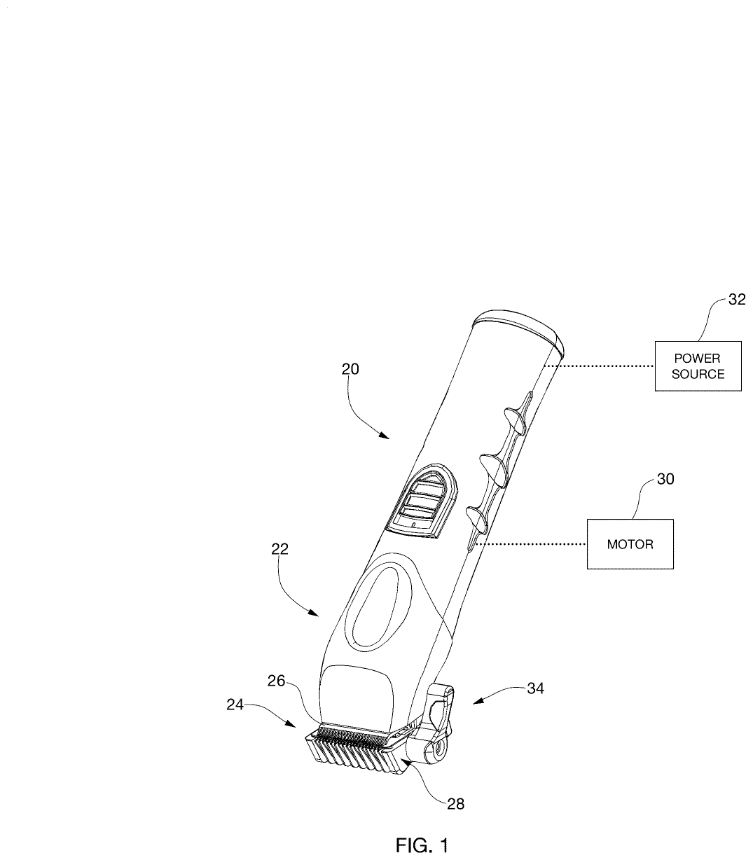

Turning now to the drawings, FIG. 1 illustrates an exemplary embodiment of an electric hair cutting device embodied herein for non-limiting example as a hair trimmer 20. Hair trimmer 20 includes a housing 22 having an end portion upon which a bladeset 24 is mounted. Bladeset 24 includes a moving blade 26 which moves relative to a stationary blade 28. While the following description will be provided in the context of a hair trimmer such as hair trimmer 20 shown in FIG. 1, the invention is not limited to the particular device illustrated, and it is envisioned that the teachings herein may be readily applied to other devices such as hair clippers. As will be understood from the following, bladeset 24 is a detachable bladeset in the sense that it may be removed from housing 22 as a self-contained unit.

Bladeset 24 includes an adjustment mechanism 34. As explained in the following, adjustment mechanism 34 advantageously provides highly precise user control of cutting length adjustment and reliably maintains a high degree of parallelism during adjustment between a leading edge of moving blade 26 and a leading edge of stationary blade 28. This parallelism enhances even cutting and enables the achievement of sharp lines in the subject's hair or at edges of the subject's hairline when performing fine detail work.

Still referring to FIG. 1, hair trimmer 20 also includes an internal electric motor 30 powered via a power source 32. Power source 32 may be embodied by an internal battery carried by housing 22 or may be an external power source such as a supply voltage provided by a wall outlet. A mechanical linkage (not shown) connects motor 32 to bladeset 24 to induce a reciprocating motion to moving blade 26 relative to stationary blade 28 to provide a cutting action. It will be recognized from the description herein that the invention is not constrained to a particular power source or a are particular motor type.

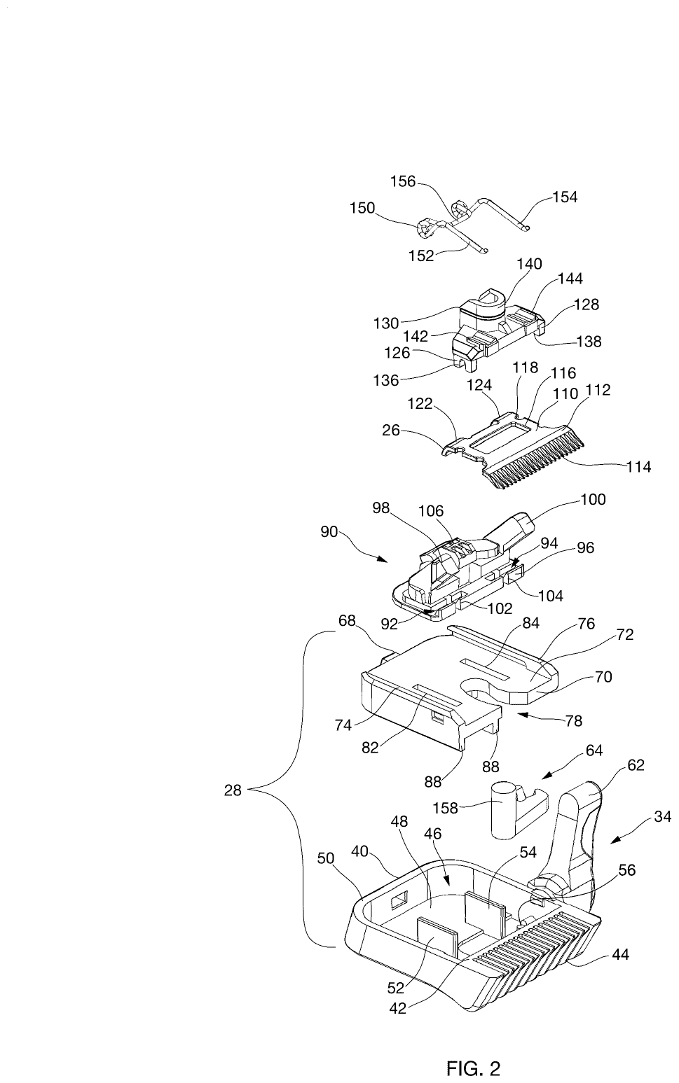

Turning now to FIG. 2, the constituent components of bladeset 24 will be discussed in greater detail. Turning first to stationary blade 28, stationary blade 28 includes a base 40. Base 40 includes a front wall 42 from which a plurality of teeth 44 extend from and which terminate at the leading edge of stationary blade 28. Base 40 also includes a cavity 46 defined by a base surface 48 as well as a peripheral wall 50 and the previously referenced front wall 42. A first guide rail 52 and a second guide rail 54 depend upwardly from base surface 48. While two guide rails 52, 54 are shown, it will be understood from the teachings herein that a single guide rail or more than two guide rails could also be employed.

A pivot pin 56 also extends upwardly from base surface 48. Pivot pin 56 serves as a pivot point for adjustment mechanism 34. Adjustment mechanism 34 includes a taper lever 62 and an armature 64. Taper lever 62 is mechanically linked with armature 64 such that rotation of taper lever 62 in a direction parallel to a longitudinal axis of the housing 22 produces a corresponding rotation of armature 64 about pivot pin 56. As described in the following, armature 64 is operably coupled between taper lever 62, moving blade 26, and a blade guide (discussed below) such that actuation of taper lever 62 results in a corresponding movement of moving blade 26.

Stationary blade 28 also includes a guide plate 68 positioned within cavity 46. While shown as separate components, it is also contemplated by the teachings herein that guide plate 68 and base 40 could be formed as a single component. Guide plate 68 includes a base wall 70 extending between a first sidewall 74 and a second sidewall 76. Base wall 70 provides a guide surface 72 as shown. When formed as a separate component, guide plate 68 may include a number of tabs or detents which are snap-fit into corresponding structures of base 40 to retain guide plate 68 on base 40. This is only one example of many, as any means of fixation may be employed to secure guide plate 68 to base 40.

A first guide rail opening 82 is formed through base wall 70. A second guide rail opening 84 is also formed through base wall 70. Guide rail openings 82, 84 are constructed and arranged to receive guide rails 52, 54. Accordingly, the number of guide rail openings will correspond with the number of guide rails employed, and as such, the number of guide rails illustrated should be taken by way of example only. A plurality of intermediary walls 88 may also be provided for additional support in supporting guide plate 68 within cavity 46. These intermediary walls 88 depend from the base wall 70 and serve to vertically space base wall 70 from base surface 48, and more particularly space guide surface 72 from base surface 48. Guide plate 68 also includes an open slot 78 allowing for movement of armature 64 as described below. As will be appreciated by those of skill in the art, the geometry of stationary blade 28 lends itself to manufacturing processes such as metal injection molding, however, any means of fabrication typical in the art of electric hair cutting devices may be employed.

Still referring to FIG. 2, bladeset 24 also includes a blade guide 90. Blade guide 90 is provided with a first guide depression 92 and a second guide depression 94, each formed in a base portion 96 of blade guide 90. First and second guide depressions 92, 94 are aligned as shown.

Blade guide 90 also includes a first guide channel 102 and a second guide channel 104, each formed in base portion 96. As can be seen in FIG. 2, first guide depression 92 intersects and is in communication with first guide channel 102 such that they are generally perpendicular to one another. Second guide depression 94 intersects and is in communication with second guide channel 104 such that they are generally perpendicular to one another. First and second guide channels 102, 104 are arranged such that they are aligned with first and second guide rail openings 82, 84, respectively. Accordingly, the number of guide channels and guide depressions will also correspond to the number of guide rail openings employed, and as such, the particular number of guide depressions and guide channels shown should be taken by way of example only.

First and second guide rails 52, 54 extend through guide rail openings 82, 84 and into first and second guide channels 102, 104, respectively. As will be understood from the following, this arrangement promotes linear sliding movement of blade guide 90 as it moves along guide surface 72 under the action of adjustment mechanism 34. Put differently, the extension of first and second guide rails 52, 54 into first and second guide channels 102, 104 ensures that blade guide 90 does not rock or tilt as it slides toward and away from teeth 44 of stationary blade 28.

Blade guide 90 also includes first and second mounting structures 98, 100 used for attaching bladeset 24 to housing 22 as is shown in FIG. 1. A spring retaining structure 106 is situated between first and second mounting structures 98, 100 as shown and is configured to retain a spring 150 described in greater detail below.

Still referring to FIG. 2, moving blade 26 includes a base portion 110 having a front edge 112. A plurality of teeth 114 extend from front edge 112 and terminate at a leading edge. A guide opening 116 is formed through base portion 110. Additionally, one or more retaining features 118 on base portion 110 of moving blade 26 may be provided for interlocking moving blade 26 with a cam follower (described below) to minimize relative movement between moving blade 26 and the cam follower. A first heel portion 122 extends from base portion 110. A second heel portion 124 also extends from base portion 110. First heel portion 122 is received in first guide depression 92. Second heel portion 124 is received in second guide depression 94. First and second heel portions 122, 124 reciprocate within first and second guide depressions 92, 94, respectively, due to the reciprocation of moving blade 26.

Bladeset 24 also includes a cam follower 130. Cam follower 130 includes first and second retaining portions 126, 128 arranged to surround base portion 110 of moving blade 26 and exert a side bearing force upon same causing moving blade 26 to reciprocate relative to stationary blade 28. First and second retaining portions 126, 128 may also include first and second identical notches 136, 138, respectively as shown, for mass reduction and/or for guiding cam follower in some embodiments as described below. Cam follower 130 includes a cam receiver 140 configured to receive an eccentric cam (not shown) of motor 30 (FIG. 1). As is familiar to those of skill in the art, this configuration converts rotary motion of the drive shaft of motor 30 into a linear reciprocating motion imparted to cam follower 130, and hence to moving blade 26 given the abutment and connection of first and second retaining portions 126, 128 with base portion 110 of moving blade 26. However, it is contemplated by the teachings herein that other mechanical drive arrangements could also be utilized to reciprocate moving blade 26. For example, a pivot motor having a pivot arm arrangement could also be utilized. Accordingly, the inclusion of cam follower 130 and spring 150 is for exemplary purposes only.

Cam follower 130 also includes a first spring arm receiver 142 and as second spring arm receiver 144. First spring arm receiver 142 receives an end of a first spring arm 152 of spring 150. Second spring arm receiver 144 receives an end of a second spring arm 154. A center portion 156 of spring 150 is retained by spring retaining structure 106. Spring arms 152, 154 exert a downward force against cam follower 130, and hence against moving blade 26. This downward spring force ensures that moving blade 26 remain in contact with stationary blade 28 as it reciprocates.

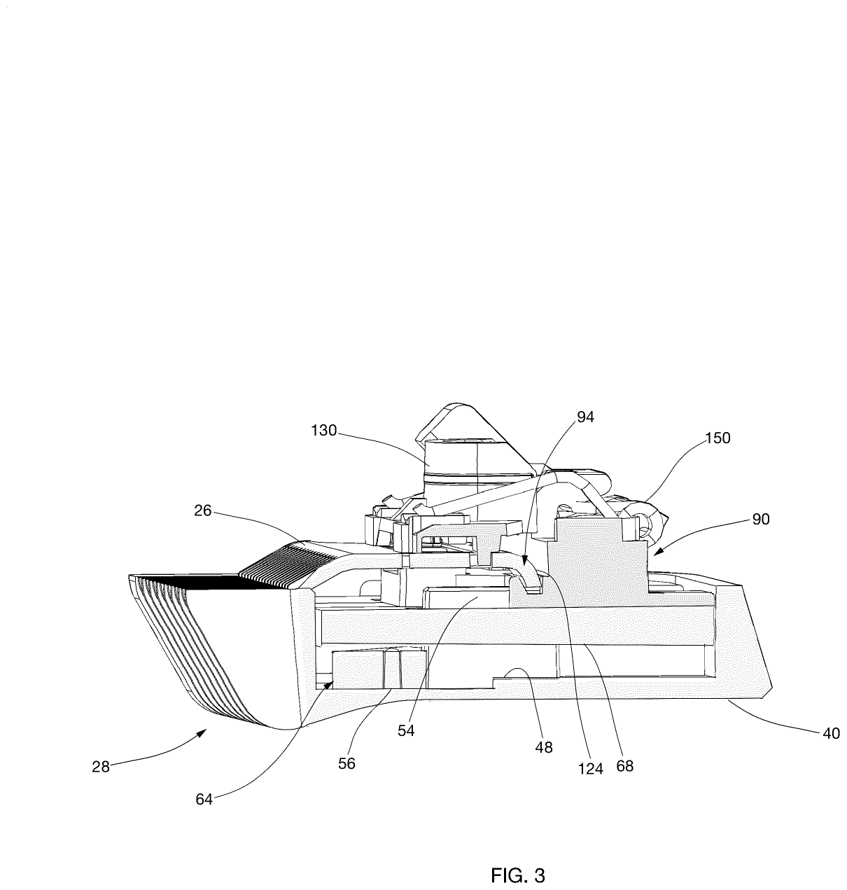

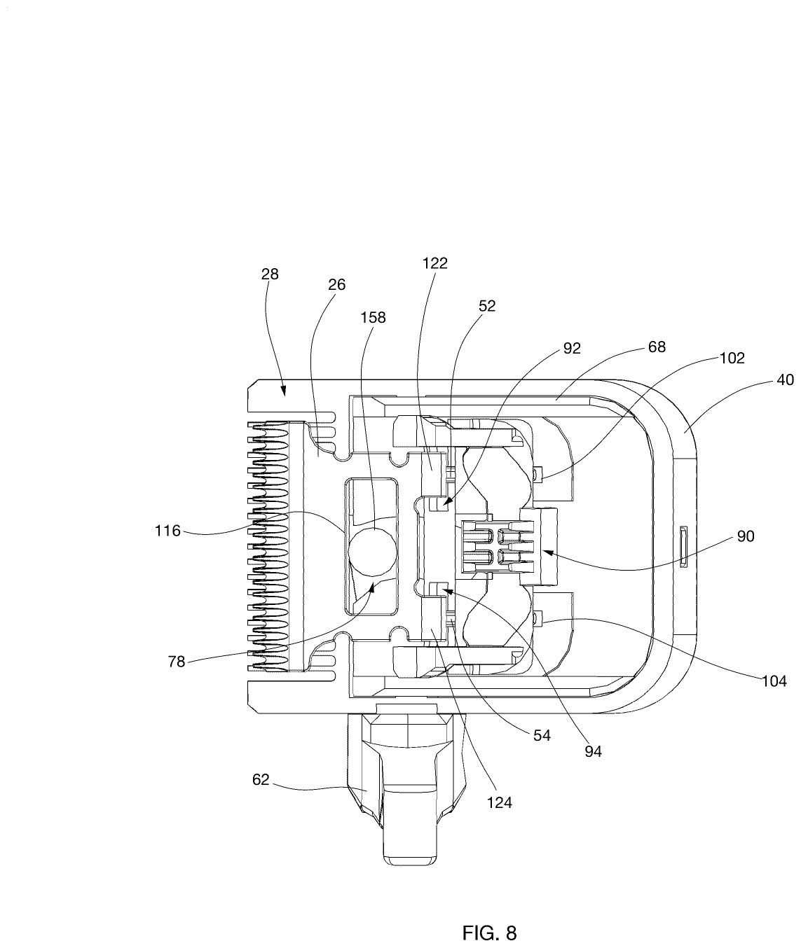

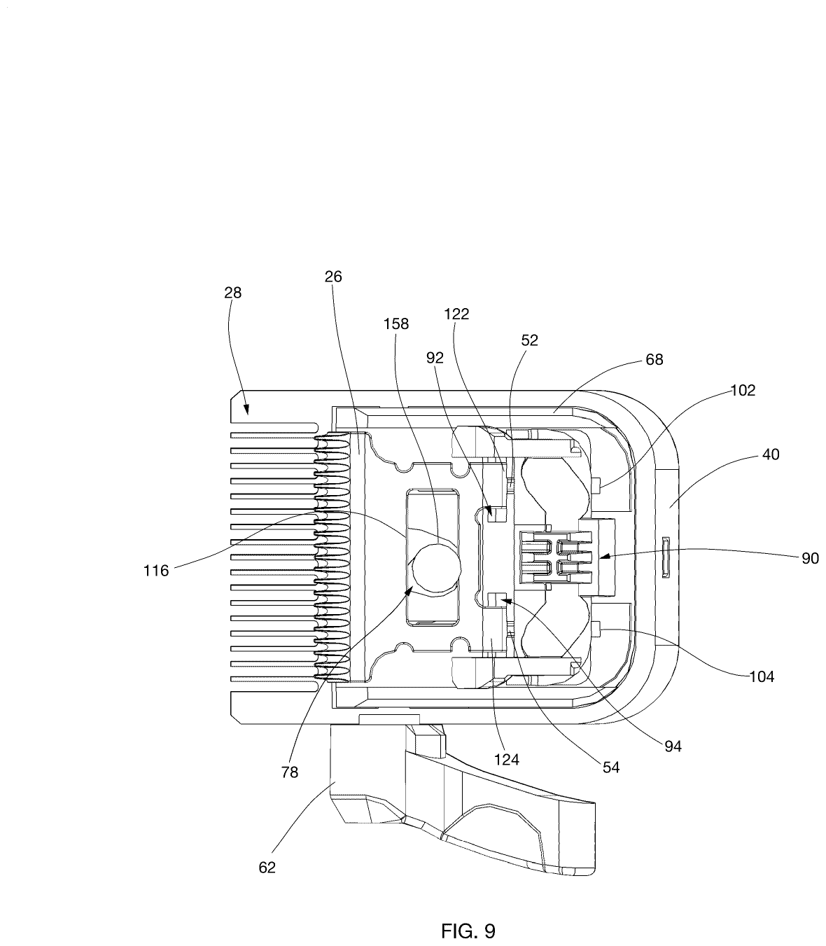

FIG. 3 depicts a cross section through second guide depression 94 to illustrate in greater detail the placement of second heel portion 124 therein. A like configuration as shown applies equally well to first heel portion 122, first guide depression 94, and first guide rail 52, respectively. To accommodate reciprocation of moving blade 26, first and second guide depressions 92, 94 are arranged to constrain movement of first and second heel portions 122, 124 respectively within first and second guide depressions 92, 94 to a substantially linear motion within a channel-like opening of first and second guide depressions 92, 94. Because first and second guide rails 52, 54 respectively extend into first and second guide channels 102, 104, and because first and second guide channels 102, 104 intersect with first and second guide depressions 92, 94, first and second heel portions 122, 124 are also supported by first and second guide rails 52, 54, respectively, within first and second guide depressions 92, 94 as may also be seen for example in FIGS. 8 and 9.

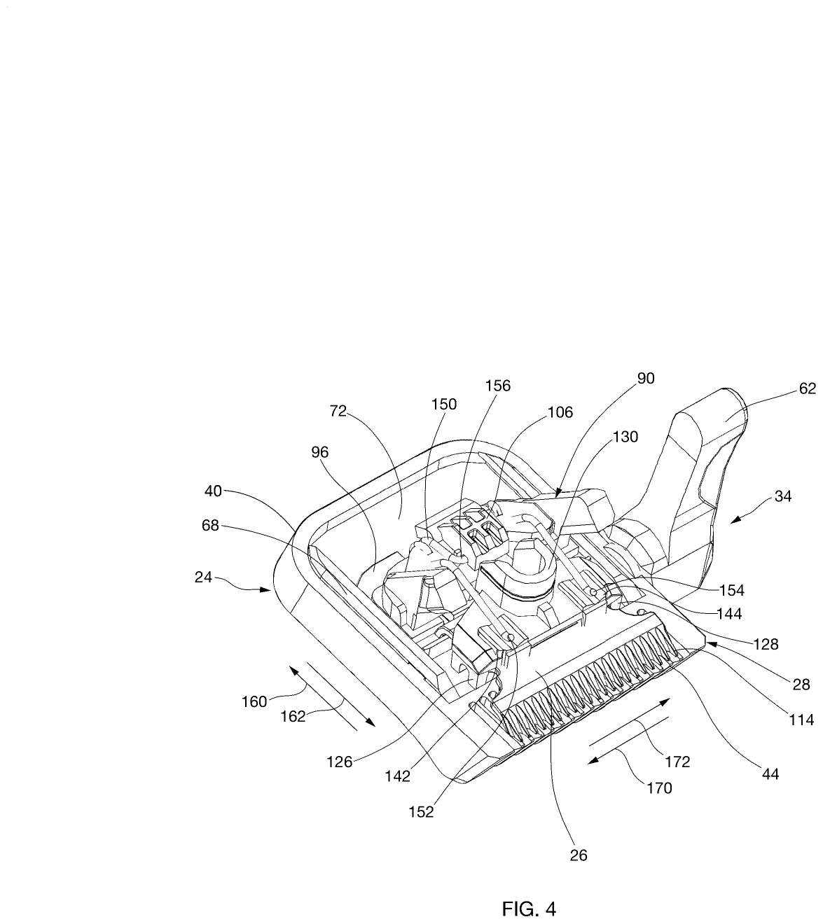

Turning now to FIG. 4, upon actuation of adjustment mechanism 34, and more particularly taper lever 62 thereof, moving blade 26, cam follower 130, and blade guide 90 are slidable in adjustment directions 160, 162. Moving blade 26 reciprocates in first and second cutting directions 170, 172 which are perpendicular to first and second adjustment directions 160, 162.

Adjustment in first and second adjustment directions 160, 162 governs the position of teeth 114 of moving blade 26 relative to teeth 44 of stationary blade 28. Teeth 44 have a varying height progressing and increasing from the tips of the teeth back toward an opposite end of stationary blade 28. As such, the particular position of moving blade 26 teeth 44 will dictate how far hair must extend through teeth 44 before being sheared off by teeth 114 of moving blade 26. As such, adjustment in first and second adjustment directions 160, 162 will govern the length of hair cut.

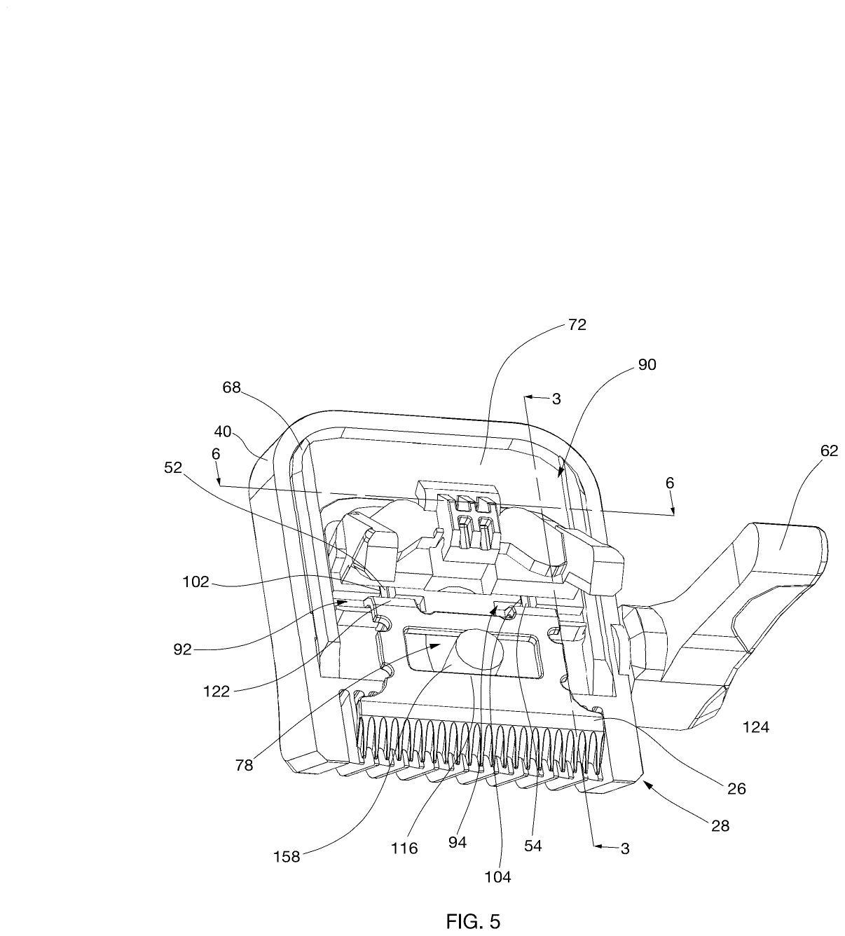

With reference now to FIG. 5, cam follower 130 and spring 150 have been removed for clarity. Armature 64 (see FIG. 2) includes a pin portion 158 which extends upwardly and away from base surface 48 (see FIG. 2), and into guide opening 116 of moving blade 26. As mentioned above, armature 64 is pivotally mounted to stationary blade 28 about a pivot pin 56. As armature 64 pivots, pin portion 158 moves toward and away from teeth 44, 114 within open slot 78. This movement of pin portion 158 causes a movement of moving blade 26 in first and second adjustment directions 160, 162 (see FIG. 4) due to the abutment of pin portion 158 with the sidewalls of guide opening 116 as may be surmised from inspection of FIG. 5.

First and second heel portions 122, 124 are received in first and second guide depressions 92, 94 such that guide depressions 92, 94 interlock with heel portions 122, 124. As a result, movement of moving blade 26 also causes a linear movement of blade guide 90, and as such, blade guide 90 is slidable along guide surface 72. The extension of first and second guide rails 52, 54 into first and second guide channels 102, 104 ensures that blade guide 90 does not rock during sliding which could otherwise cause moving blade 26 to reciprocate in a manner out of parallel with the leading edge of stationary blade 28.

Indeed, first and second heel portions 122, 124 are received in guide depressions 92, 94 which are provided with aligned channels. This alignment and channel configuration ensures that moving blade 26 reciprocates in a straight line. Because first and second guide depressions 92, 94 are on blade guide 90, blade guide 90 is prevented from rocking and also maintains moving blade 26 linearly aligned with stationary blade 28 to provide enhanced cutting performance.

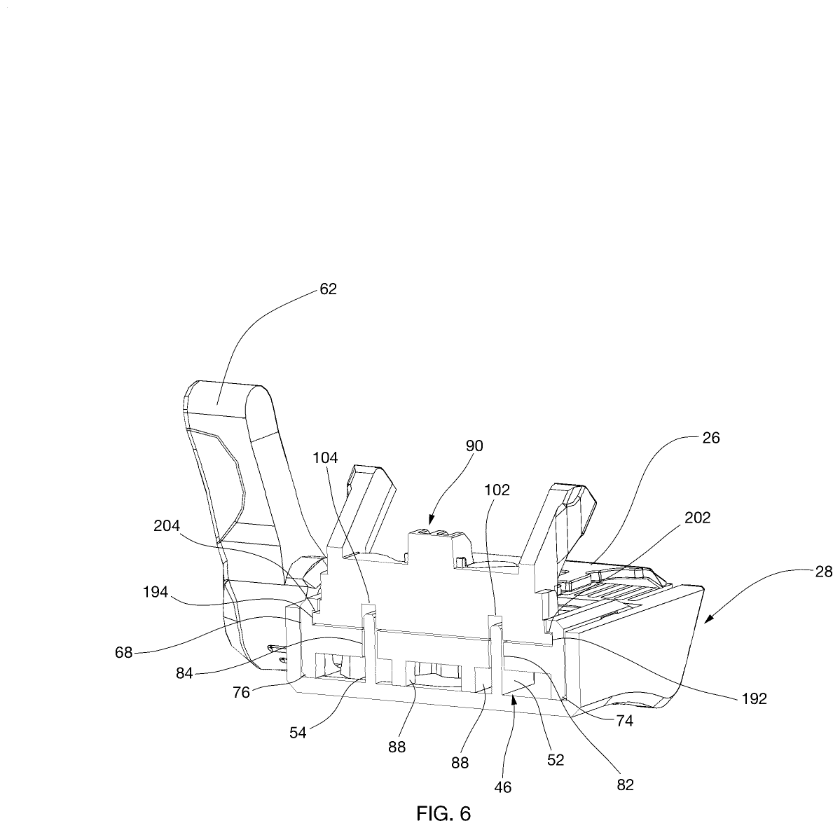

With reference now to FIG. 6, the upward extension of first and second guide rails 52, 54 into first and second guide channels 102, 104 is shown in cross section. As may also be seen in this view, first sidewall 74 of guide plate 68 is provided with a first blade guide receiving channel 192, which receives a first blade guide portion 202 of blade guide 90. Second sidewall 76 of guide plate 68 includes a second blade guide receiving channel 194 which receives a second blade guide portion 204 in opposed spaced relation to first blade guide portion 202.

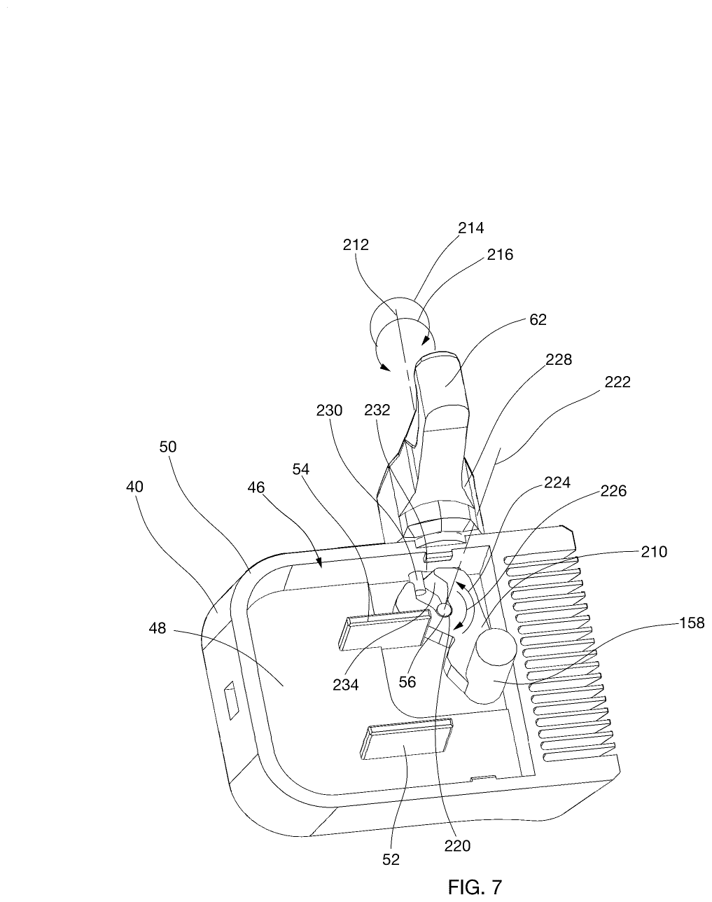

Turning now to FIGS. 7-9, a more detailed description of the aforementioned adjustment mechanism 34 (see also FIG. 1) will be provided. With reference to FIG. 7, adjustment mechanism 34 and stationary blade 28 will be described in greater detail. Guide plate 68 has been removed from base 40 of stationary blade 28 for purposes of illustrating the position of armature 64 within cavity 46. Armature 64 is pivotally mounted on pivot pin 56. Armature 64 includes an arm portion 210 from which pin portion 158 extends. Arm portion 210 is generally claw shaped at one end and includes a relief 220 for receipt of pivot pin 56 as shown. Armature 64 is pivotable about a pivot axis 222 defined by pivot pin 56 in first and second rotational directions 224 and 226 as illustrated. Pivot axis 222 is perpendicular to base surface 48, as well as guide surface 72 (see e.g., FIG. 5).

Taper lever 62 includes a generally round collar portion 228 from which an adjustment pin 230 extends. Adjustment pin 230 extends through an arcuate opening 232 formed through peripheral wall 50 of base 40. The shape of arcuate opening 232 generally assumes the arcuate path traveled by adjustment pin 230 as taper lever 62 rotates about an adjustment axis 212 in first and second rotational directions 214, 216.

Adjustments pin 230 is in slidable engagement with a cam surface 234 of arm portion 210. Cam surface 234 is shaped such that pin 230 is in slidable engagement therewith throughout its range of motion when taper lever 62 is rotated about axis 212. In FIG. 7, taper lever 62 has been rotated about adjustment axis 212 in direction 214, thereby bringing pin 230 to the position shown. This movement of pin 230 acts against cam surface 234 so as to cause simultaneous rotation of armature 64 about pivot axis 222 in rotational direction 224 as shown. In this way, pin 158 is rotated forward and towards teeth 44.

Referring to FIG. 8, movement of pin 158 towards teeth 44 slides moving blade 26 and blade guide 90 on guide surface 72 to finely adjust the position of moving blade 26 relative to stationary blade 28 to produce a shorter hair length after cutting. Pin 158 effectively pulls moving blade 26 and blade guide 90 forward due to the overlapped and interlocked configuration of first and second heel portions 122, 124 with first and second guide depressions 92, 94.

Referring momentarily back to FIG. 7, rotation of taper lever 62 about adjustment axis 212 in rotational direction 216 moves adjustment pin 230 to a position within arcuate opening 232 opposite that shown in FIG. 7. This causes a sliding engagement with cam surface 234, and a like rotation of armature 64 about pivot axis 222 in direction 226. This rotation to transitions adjustment pin 158 away from teeth 44 of stationary blade 28.

Turning now to FIG. 9 movement of pin 158 away from teeth 44 slides moving blade 26 and blade guide 90 on guide surface 72 to finely adjust the position of moving blade 26 relative to stationary blade 28 to produce a longer hair length after cutting. Adjustment pin 158 effectively pushes moving blade 26 and blade guide 90 rearward due to the overlapped and interlocked configuration of first and second heel portions 122, 124 with first and second guide depressions 92, 94.

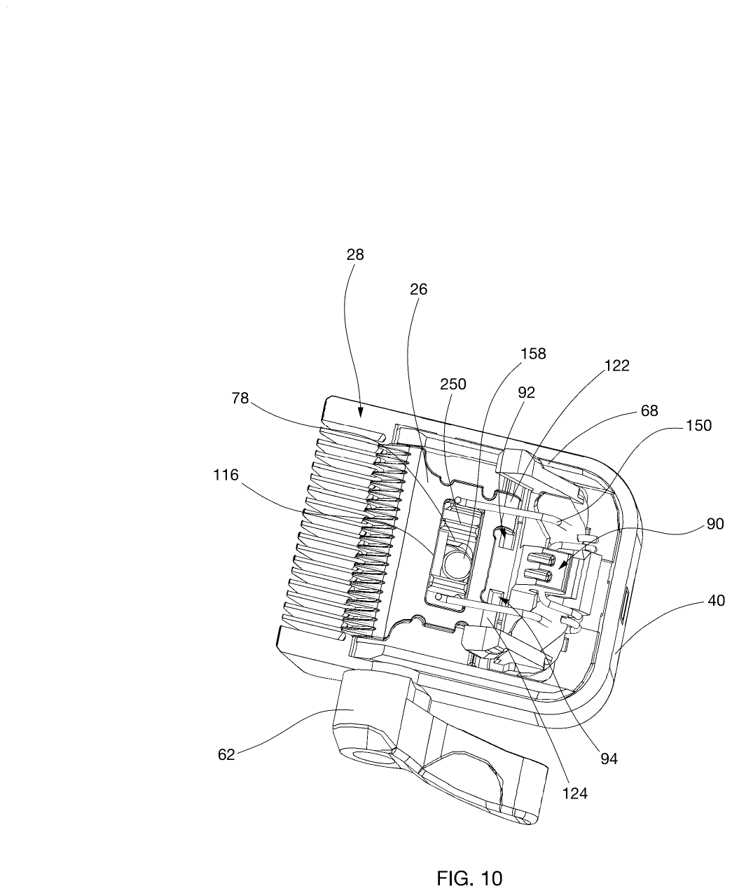

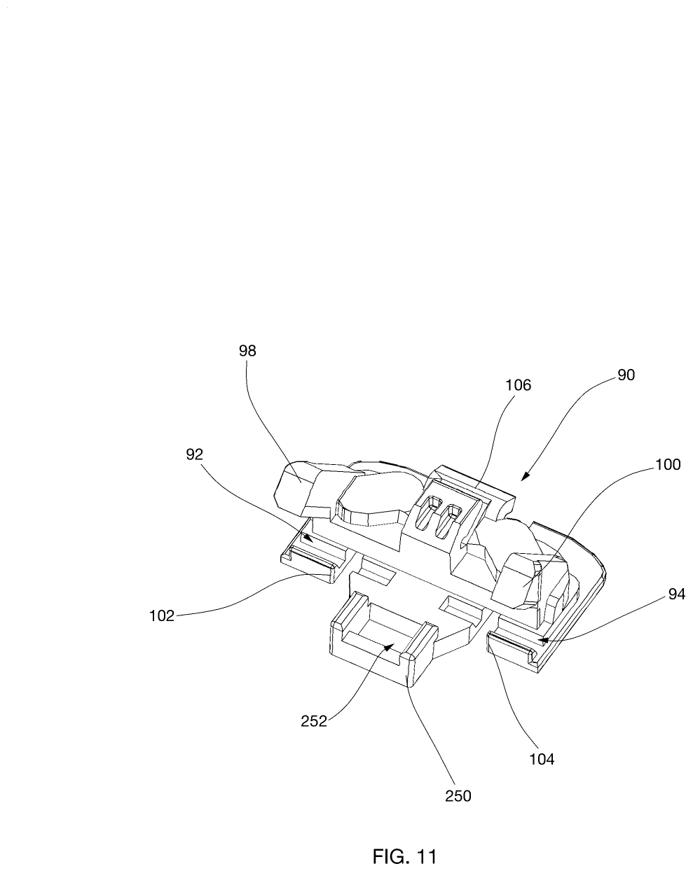

With reference now to FIG. 10, bladeset 24 is shown with an alternative configuration of blade guide 90 with cam follower 130 removed for clarity. In this configuration, blade guide 90 includes a guide structure 250 which nests in guide opening 116. The adjustment of moving blade 26 functions as described above. This alternative configuration of blade guide 90 is also shown in FIG. 11 for additional clarity. Guide structure 250 receives pin 158 in an open pin receiving portion 252 that is sized to generally approximate the inner periphery of guide opening 116. In this way, pin 158 acts upon guide structure 250, which in turn acts upon guide opening 116 to move moving blade 26 as described above.

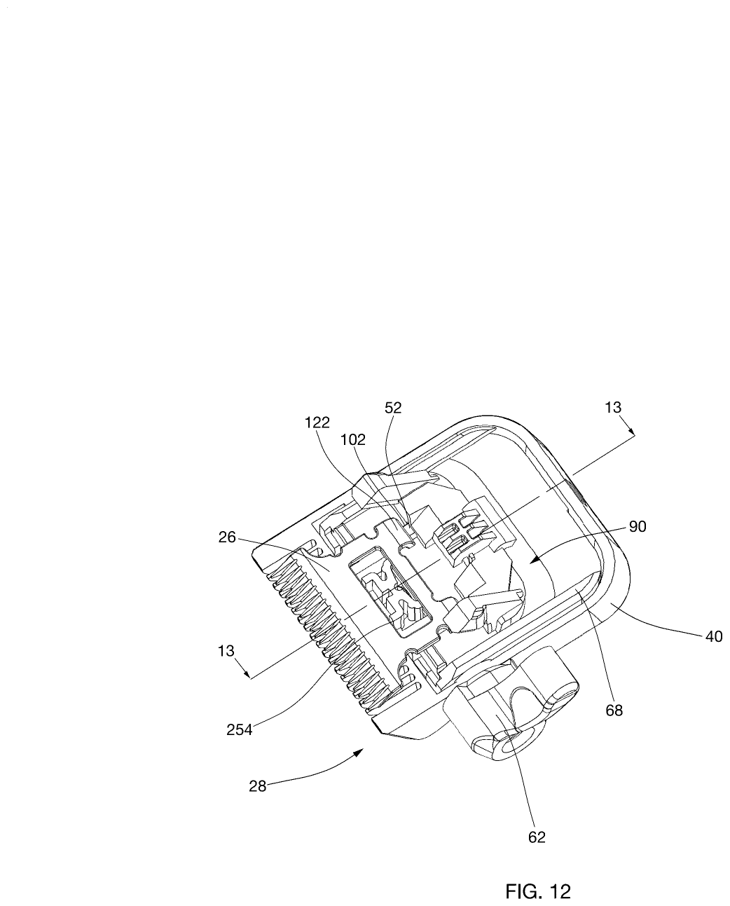

Turning now to FIG. 12, bladeset 24 is shown with another alternative configuration of blade guide 90. In this view, cam follower 130 and spring 150 have been removed for clarity. Blade guide 90 also includes a guide structure 254 like guide structure 250 shown in FIGS. 10-11. However, guide structure 254 does not include a full opening similar to what is shown in FIGS. 10-11 relative to pin receiving portion 252.

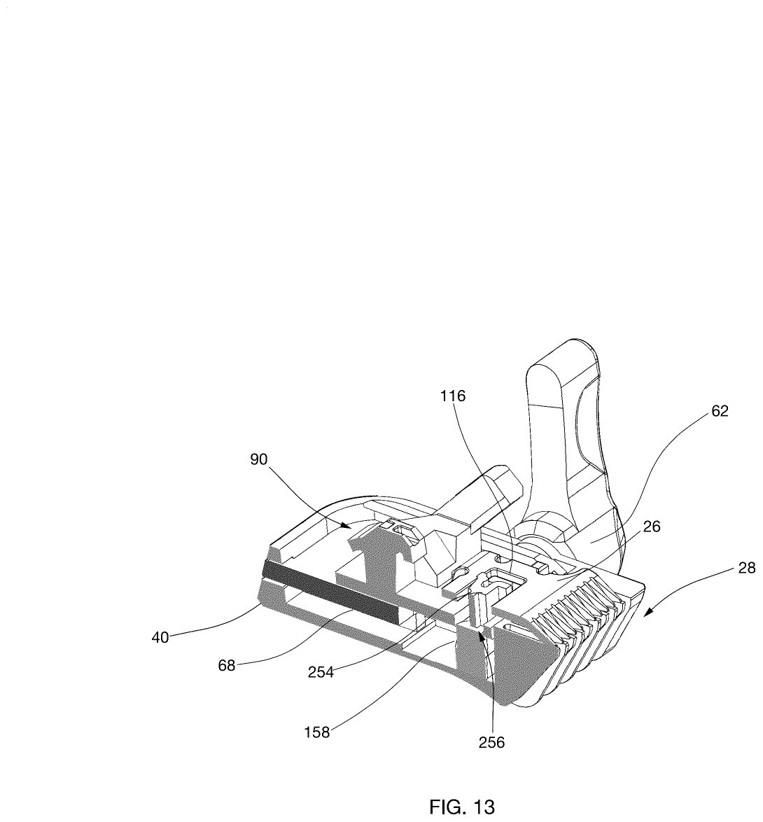

Instead, and turning now to the cross section shown in FIG. 13, in this alternative configuration of blade guide 90, guide structure 254 includes a pin receiving portion 256 which is a recess formed in an underside of blade guide 90 as shown. In this way, pin 158 acts upon guide structure 254, which in turn acts upon guide opening 116 to move moving blade 26 as described above.

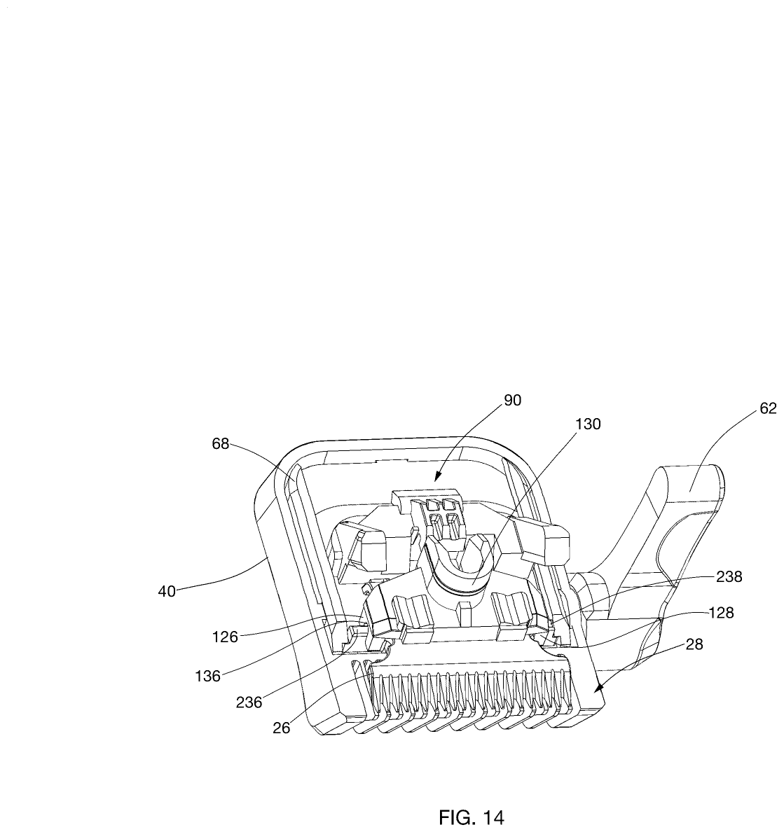

With reference to FIG. 14, also in this alternative configuration of blade guide 90, first and second guide depressions 92, 94 are omitted in favor of first and second guide tabs 236, 238 which depend upwardly from a leading edge of blade guide 90. First and second guide tabs 236, 238 are received, respectively, in first and second notches 136, 138, respectively, of first and second retaining portions 126, 128 of cam follower 130 (see also FIG. 2).

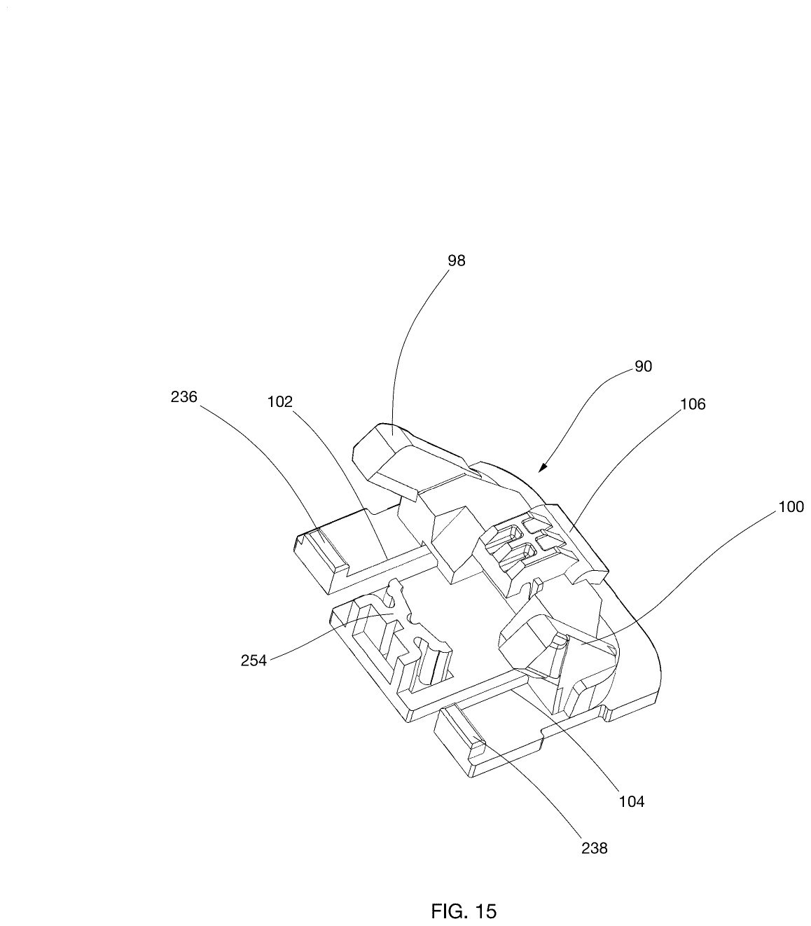

As may be surmised from inspection of FIG. 15 which illustrates this alternative configuration of blade guide 90 alone, first and second guide tabs 236, 238 are aligned with one another and thus serve to constrain the reciprocating motion of cam follower 130 along a single axis. Because cam follower 130 is interlocked with moving blade 26 as described above, moving blade 26 is also constrained to this single axis of reciprocation, which is also shown by way of cutting directions 170, 172 shown in FIG. 4.

In this alternative configuration of blade guide 90, first and second guide depressions 92, 94 (see e.g. FIG. 2) are omitted as mentioned above. However, first and second heel portions 122, 124 remain supported by first and second guide rails 52, 54 which depend through first and second guide rail openings 82, 84 and first and second guide channels 102, 104 as described above, and as is shown via heel portion 122, guide rail 52, and guide rail opening 82.

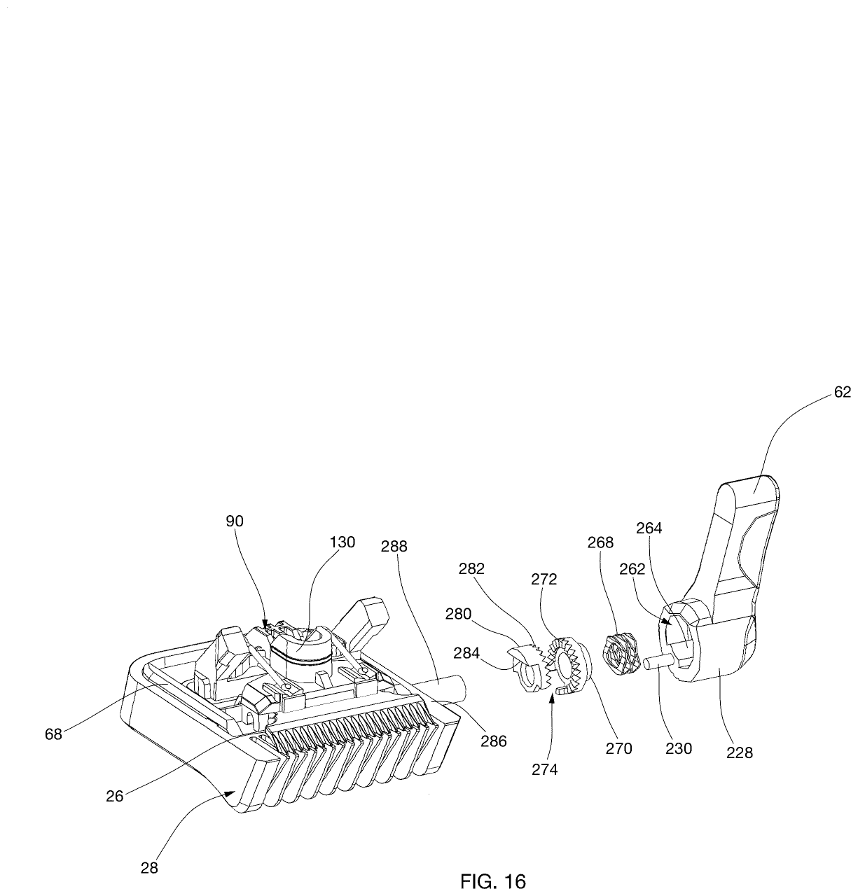

Turning to FIG. 16, adjustment mechanism may also include an optional audible/tactile function integrated with taper lever 62. Taper lever 62 includes a cavity 262, with a keyed portion 264. An actuating pin 230 extends outwardly from taper lever 62 and, as described below, acts upon armature 64 (see FIG. 2) to pivot same.

A biasing element in the form of a wave spring 268 is situated within cavity 262. Wave spring 268 acts upon a first gear 270 to bias it into engagement with a second gear 280. First gear 270 includes a plurality of gear teeth 272, as well as a keyway 274 which receives keyed portion 264. As such, first gear 270 rotates with taper lever 62 as it is rotated in directions 214, 216 (see FIG. 7). Second gear 280 is also disposed within cavity 262. Second gear also includes a plurality of teeth 282 which face and engage teeth 272 of first gear 270. Second gear includes a ledge portion 284 which abuts a top surface 286 of sidewall 50 of stationary blade 28.

Taper lever 62, first gear 270, second gear 280, and wave spring 268 are rotatable mounted on a sleeve 288. However, because ledge portion 284 abuts top surface 286, second gear 280 cannot rotate relative to stationary blade 28 about sleeve 288. As mentioned above, however, first gear 270 rotates with rotation of taper lever 62 which can rotate relative to sleeve 288, and hence is rotatable relative to second gear 280. This relative motion causes teeth 272, 282 to move relative one another. Due to the biasing force provided by wave spring 268, a consistent engagement and disengagement of teeth 272, 282 occurs, causing an audible clicking noise as taper lever 62 is rotated. This engagement and disengagement of the teeth also adds a desirable tactile feeling to the operation of taper lever 62.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A bladeset for an electric hair cutting device, comprising:
a stationary blade including a plurality of teeth and including at least one guide rail extending transversely from a base surface of the stationary blade;
a moving blade including a plurality of teeth, the moving blade operable to reciprocate in first and second cutting directions relative to the stationary blade to produce a cutting action;
an adjustment mechanism operably coupled to the moving blade to adjust the moving blade in first and second adjustment directions, wherein the first and second adjustment directions are perpendicular to both the first and second cutting directions;
a blade guide including at least one guide channel formed therein; and
wherein the at least one guide rail extends at least partially into the at least one guide channel and is in contact with the moving blade.

2. The bladeset of claim 1, wherein the at least one guide rail includes first and second guide rails arranged parallel to one another, and wherein the at least one guide channel includes first and second guide channels arranged parallel to one another, the first guide rail extending into the first guide channel, the second guide rail extending into the second guide channel.

3. The bladeset of claim 1, wherein the stationary blade includes a guide surface, wherein at least a portion of the guide surface is parallel to at least a portion of the base surface.

4. The bladeset of claim 1, wherein the moving blade includes a first end and a second end opposite the first end, the plurality of teeth of the moving blade formed at the first end, wherein the second end includes at least one heel portion, and wherein the blade guide includes at least one guide depression, wherein the at least one heel portion is received within the at least one guide depression.

5. The bladeset of claim 4, wherein the at least one heel portion includes a first heel portion and a second heel portion, wherein the at least one guide depression includes a first guide depression and a second guide depression, the first heel portion received in the first guide depression, the second heel portion received in the second guide depression.

6. The bladeset of claim 4, wherein the at least one guide depression and the at least one guide channel intersect, such that the at least one heel portion is movable within the at least one guide depression perpendicularly to the at least one guide channel.

7. The bladeset of claim 6, wherein the at least one guide depression and the at least one guide channel intersect such that the at least one guide rail supports the at least one heel portion within the at least one guide depression.

8. A bladeset for an electric hair cutting device, comprising:
a stationary blade including a plurality of teeth and including at least one blade guide receiving channel formed in a sidewall of the stationary blade;
a moving blade including a plurality of teeth, the moving blade operable to reciprocate in first and second cutting directions relative to the stationary blade to produce a cutting action;
an adjustment mechanism operably coupled to the moving blade to adjust the moving blade in first and second adjustment directions, wherein the first and second adjustment directions are perpendicular to both the first and second cutting directions;
a blade guide contacting the stationary blade, the blade guide including at least one guide portion; and
wherein the at least one guide portion of the blade guide is received within the at least one blade guide receiving channel of the stationary blade.

9. The bladeset of claim 8, wherein the at least one blade guide receiving channel of the stationary blade includes a first blade guide receiving channel and a second blade guide receiving channel, and wherein the at least one blade guide portion of the blade guide includes a first blade guide portion and a second blade guide portion, the first blade guide portion received within the first blade guide receiving channel, the second blade guide portion received within the second blade guide receiving channel.

10. The bladeset of claim 8, wherein the at least one blade guide receiving channel includes a first blade guide receiving channel and a second blade guide receiving channel arranged parallel to the first blade guide receiving channel, the first blade guide receiving channel formed in a first sidewall of the stationary blade, and the second blade guide receiving channel formed in a second sidewall of the stationary blade.

11. The bladeset of claim 8, wherein the stationary blade includes a base and a guide plate, the guide plate positioned within a cavity of the base.

12. The bladeset of claim 11, wherein the guide plate defines a guide surface, the blade guide slidable on the guide surface.

13. A bladeset for an electric hair cutting device, comprising:
a stationary blade including a plurality of teeth and including a cavity;
a moving blade including a plurality of teeth, the moving blade operable to reciprocate relative to the stationary blade to produce a cutting action;
a blade guide contacting the stationary blade;
an adjustment mechanism including a taper lever and an armature, the armature operably coupled between the taper lever and the blade guide such that the blade guide and the moving blade are movable relative to the stationary blade upon actuation of the taper lever; and
wherein the armature is pivotally mounted to the stationary blade.

14. The bladeset of claim 13, wherein the stationary blade includes a base surface and a guide surface, wherein at least a portion of the base surface is parallel to at least a portion of the guide surface.

15. The bladeset of claim 14, wherein the cavity of the stationary blade is interposed between the base surface and the guide surface.

16. The bladeset of claim 13, wherein the armature is pivotally mounted on the stationary blade about a pivot axis, the pivot axis defined by a pivot pin extending from the stationary blade and wherein the armature includes a pin portion extending upwardly from a base portion.

17. The bladeset of claim 16, wherein the pin portion extends through a slot of a guide plate of the stationary blade.

18. The bladeset of claim 17, wherein the pin portion extends into a guide structure of the blade guide, the guide structure of the blade guide positioned within a guide opening of the moving blade.

19. The bladeset of claim 16, wherein the base portion of the armature includes a cam surface, the cam surface in slidable engagement with a pin extending from the taper lever.

20. The bladeset of claim 13, wherein the adjustment mechanism includes a first gear member, a second gear member, and a biasing element, the first gear member second gear member, and biasing element situated within a cavity of the taper lever, the biasing element biasing the first gear member into engagement with the second gear member, the first gear member movable relative to the second gear member upon actuation of the taper lever.
